(19) United States
(12) Patent Application Publication
(10) Pub. No.: US 2011/0003090 A1
(43) Pub. Date: Jan. 6, 2011

(54) TRANSPARENT ADHESIVE SHEET FOR FLAT PANEL DISPLAY

(75) Inventors: Yasushi Buzoujma, Ibaraki-shi (JP); Hidenori Suzuki, Ibaraki-shi (JP); Tatsuya Suzuki, Ibaraki-shi (JP); Tomohide Banba, Ibaraki-shi (JP); Katsuya Kume, Ibaraki-shi (JP); Kazuhiko Ueda, Osaka-shi (JP)

Correspondence Address: SUGHRUE MION, PLLC, 2100 PENNSYLVANIA AVENUE, N.W., SUITE 800, WASHINGTON, DC, 20037, US

(73) Assignees: NITTO DENKO CORPORATION, Ibaraki-shi, Osaka (JP); KANEKA CORPORATION, Osaka-shi, Osaka (JP)

(21) Appl. No.: 12/867,737

(22) PCT Filed: Feb. 13, 2009
(86) PCT No.: PCT/JP2009/052366

§ 371 Date: Aug. 13, 2010

(30) Foreign Application Priority Data
Feb. 15, 2008 (JP) 034769/2008

(51) Int. Cl. C09K 19/02; C08K 5/3435

(52) U.S. Cl. 428/1.5; 524/99

(57) ABSTRACT

Provision of a transparent adhesive sheet for flat panel display, which has superior light resistance.

A transparent adhesive sheet for flat panel display, which contains a polyoxyalkylene based polymer as a main component, and a hindered amine based light stabilizer represented by the formula (I):

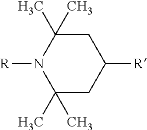

wherein R is an alkyl group or an alkylcarbonyl group, and R′ is a hydrogen atom or an organic group bonded to the 4-position of a piperidyl group via oxygen or nitrogen. Preferably, a transparent adhesive sheet for flat panel display, which is made of a cured product of a composition containing components A-D below:
A: a polyoxyalkylene based polymer having at least one alkenyl group in each molecule
B: a compound having an average of two or more hydrosilyl groups in each molecule
C: a hydrosilylation catalyst, and
D: a hindered amine based light stabilizer of the formula (I) above.

### TECHNICAL FIELD

The present invention relates to a transparent adhesive sheet for flat panel display, and particularly, a transparent adhesive sheet for flat panel display, which has superior light resistance.

### BACKGROUND ART

Conventionally, in a flat panel display such as a liquid crystal display and the like, the display panel and a transparent protective plate such as acrylic board, glass plate and the like, which protects the display panel, are set with a given gap so that, when an impact of some kind is applied to the flat panel display, the impact will not be transmitted to the display panel. However, since the gap is generally a layer of air, light reflection loss is high due to the difference in the refractive index between the layer of air and the material constituting the above-mentioned display panel and transparent protective plate, thus problematically failing to afford good visibility. In recent years, therefore, a technique for eliminating the clearance (layer of air) between a liquid crystal panel and a transparent protective plate has been proposed by integrally adhering the transparent protective plate to the liquid crystal panel via a transparent adhesive sheet (patent documents 1, 2).

The present applicant has also proposed a transparent adhesive sheet comprising a polyoxyalkylene based polymer as a main component as a transparent adhesive sheet for a flat panel display, which can palliate such external impact on the display panel and improve visibility (patent documents 3, 4).

patent document 1: JP-A-2004-212521
patent document 2: JP-A-2002-348546
patent document 3: WO2006/109841
patent document 4: Japanese patent application No. 2007-112194

### DISCLOSURE OF THE INVENTION

### Problems to be Solved by the Invention

The present inventors have conducted further studies and found that, in a transparent adhesive sheet for flat panel display which receives not only the outside light but also the light from a display panel, suppression of photo-deterioration (i.e., improvement of light resistance) is an extremely important technical problem for the maintenance of stable properties. Accordingly, the problem to be solved by the present invention is provision of a transparent adhesive sheet for flat panel display, which has superior light resistance.

### Means of Solving the Problems

The present inventors have conducted intensive studies in an attempt to solve the aforementioned problems and found that, in a transparent adhesive sheet comprising a polyoxyalkylene based polymer as a main component, an adhesive sheet capable of maintaining a sheet form and high transparency even when exposed to photoirradiation can be obtained only when a hindered amine based light stabilizer having a particular molecular structure is added, which resulted in the completion of the present invention.

Accordingly, the present invention provides the following.

(1) A transparent adhesive sheet for flat panel display, comprising a polyoxyalkylene based polymer as a main component and a hindered amine based light stabilizer represented by the formula (I):

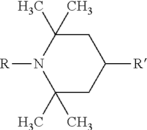

wherein R is an alkyl group or an alkylcarbonyl group, and R′ is a hydrogen atom or an organic group bonded to the 4-position of a piperidyl group via oxygen or nitrogen.
(2) The transparent adhesive sheet for flat panel display described in (1) above, which consists of a cured product obtained by curing an adhesive composition comprising the following components A to D:

A: a polyoxyalkylene based polymer having at least one alkenyl group in each molecule

B: a compound having an average of two or more hydrosilyl groups in each molecule

C: a hydrosilylation catalyst, and

D: a hindered amine based light stabilizer represented by the formula (I):

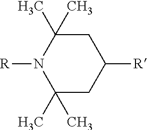

wherein R is an alkyl group or an alkylcarbonyl group, and R′ is a hydrogen atom or an organic group bonded to the 4-position of a piperidyl group via oxygen or nitrogen.
(3) The transparent adhesive sheet for flat panel display described in (2) above, wherein the amount of component D is 0.05-5 wt % relative to component A.
(4) A flat panel display comprising a display panel and the transparent adhesive sheet of any of the above-mentioned (1)-(3), which is adhered to the display panel.

### EFFECT OF THE INVENTION

According to the present invention, a transparent adhesive sheet for flat panel display can be obtained, which is capable of maintaining a sheet form and high transparency over a long period even when exposed to the outside light (sunlight) or the light from a display panel. Therefore, using the transparent adhesive sheet of the present invention for flat panel display, a high-performance flat panel display superior in the impact resistance and visibility of the display panel, which can stably maintain such superior properties for a long time, can be realized.

### BEST MODE FOR CARRYING OUT THE INVENTION

The present invention is explained in the following by referring to a preferable embodiment.

The transparent adhesive sheet of the present invention for flat panel display (hereinafter to be also simply abbreviated as “a transparent adhesive sheet”) is a transparent adhesive sheet characteristically comprising a polyoxyalkylene based polymer as a main component, and a hindered amine based light stabilizer represented by the formula (I):

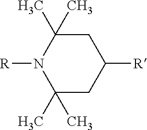

wherein R is an alkyl group or an alkylcarbonyl group, and R′ is a hydrogen atom or an organic group bonded to the 4-position of a piperidyl group via oxygen or nitrogen (hereinafter to be also abbreviated as “hindered amine based light stabilizer of the formula (I)”). It is preferably a transparent adhesive sheet comprised of a cured product obtained by curing an adhesive composition comprising the following components A-D.

A: a polyoxyalkylene based polymer having at least one alkenyl group in each molecule

B: a compound having an average of two or more hydrosilyl groups in each molecule

C: a hydrosilylation catalyst, and

D: a hindered amine based light stabilizer of the formula (I)

The reason why the hindered amine based light stabilizer of the formula (I) yields preferable results in the present invention is not clear. However, it is considered that the active radical generated in the main chain of polyoxyalkylene based polymer, which causes photodecomposition of polyoxyalkylene based polymer, is effectively trapped by a hindered amine based light stabilizer showing a low rate of dissociation of the substituent bonded to the nitrogen atom of 2,2,6,6-tetramethyl-4-piperidine ring. Thus, the aforementioned formula (I) wherein R is an alkyl group or an alkylcarbonyl group is considered to extremely effectively act for trapping said active radical. In addition, since the formula (I) wherein R is an alkyl group or an alkylcarbonyl group is compatible with a polyoxyalkylene based polymer, it favorably acts on sheeting and curing reaction of an adhesive composition containing a polyoxyalkylene based polymer (particularly, composition containing components A-C) during production of a transparent adhesive sheet, as well as maintenance of the obtained sheet form, and suppresses yellowing of the obtained adhesive sheet.

Known hindered amine based light stabilizers have various molecular structures. Hindered amine based light stabilizers having a molecular structure other than the aforementioned formula (I) are hardly compatible with polyoxyalkylene based polymers to problematically cause phase separation and clouding. Although some of them are compatible with polyoxyalkylene based polymers, they are also associated with problems of yellowing of the obtained adhesive sheet and defective curing to prevent sheeting.

In the present invention, when R in the hindered amine based light stabilizer of the formula (I) is an alkyl group, examples of the alkyl group include a linear or branched alkyl group having a carbon number of 1-10 such as methyl, ethyl, propyl, t-butyl, hexyl, octyl, decyl and the like. Preferred is an alkyl group having a carbon number of 1-3, and particularly preferred is a methyl group. When R in the hindered amine based light stabilizer of the formula (I) is an alkylcarbonyl group, examples of the alkyl group of the alkylcarbonyl group include a linear or branched alkyl group having a carbon number of 1-10 such as methyl, ethyl, propyl, t-butyl, hexyl, octyl, decyl and the like. Preferred is an alkyl group having a carbon number of 1-3, and particularly preferred is a methyl group. The hindered amine based light stabilizer of the formula (I) can have plural piperidine structures in a molecule, where all piperidine structures are preferably 2,2,6,6-tetramethyl-4-piperidyl structures wherein a carbon atom is bonded to a nitrogen atom of a 2,2,6,6-tetramethyl-4-piperidine ring.

Specific examples of preferable hindered amine based light stabilizer of the formula (I) include a compound represented by the formula (II):

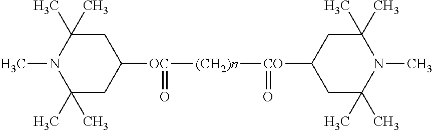

wherein n is an integer of 6-8 (preferably, bis(1,2,2,6,6-pentamethyl-4-piperidinyl)sebacate (wherein n=8)), N-(1-acetyl-2,2,6,6-tetramethyl-4-piperidinyl)-2-dodecyl-succinimide represented by the formula (III):

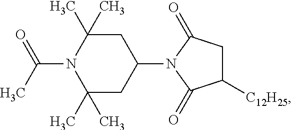

and the like.

In the present invention, the aforementioned components A-C are main components of an adhesive sheet, and a preferably embodiment thereof is as described below.

The “polyoxyalkylene based polymer having at least one alkenyl group in each molecule” of component A is not particularly limited, and various polymers can be used. Of those, a polymer having a main chain having a repeating unit shown by the following formula (1) is preferable.

—R¹—O— Formula (1)

wherein R¹ is an alkylene group.

R¹ is preferably a linear or branched alkylene group having 1 to 14, more preferably 2 to 4, carbon atoms.

As specific examples of the repeating unit represented by the formula (1), —CH₂O—, —CH₂CH₂O—, —CH₂CH(CH₃)O—, —CH₂CH(C₂H₅) O—, —CH₂C(CH₃)₂O—, —CH₂CH₂CH₂CH₂O— and the like can be mentioned. The main chain skeleton of the polyoxyalkylene based polymer may consist of only one kind of repeating unit, and may consist of two kinds or more of repeating units. Particularly, with regard to availability and workability, a polymer with —CH₂CH(CH₃)O— as the main repeating unit is preferable. In the main chain of the polymer, a repeating unit other than the oxyalkylene group may be contained. In this case, the total sum of oxyalkylene units in the polymer is preferably not less than 80% by weight, particularly preferably not less than 90% by weight.

Although the polymer may be a linear polymer or a branched polymer, or a mixture thereof, it is preferable, for obtaining good adhesiveness, that the component A polymer contain a linear polymer at not less than 50% by weight.

The molecular weight of the polymer is preferably 500 to 50,000, more preferably 5,000 to 30,000, in terms of number-average molecular weight. If the number-average molecular weight is less than 500, the cured product obtained tends to be too brittle; conversely, the polymer having the number-average molecular weight exceeding 50,000 tends to be so viscous that the workability is considerably reduced; therefore, these cases are undesirable. As mentioned herein, number-average molecular weight refers to a value obtained by the gel permeation chromatography (GPC) method.

The polymer preferably has a comparatively narrow molecular weight distribution wherein the ratio of weight-average molecular weight and number-average molecular weight (Mw/Mn) is not more than 1.6; a polymer having an Mw/Mn of not more than 1.6 produces a decreased viscosity of the composition and offers improved workability. Hence, the Mw/Mn is more preferably not more than 1.5, still more preferably not more than 1.4. As mentioned herein, Mw/Mn refers to a value obtained by the gel permeation chromatography (GPC) method.

Here, measurements of molecular weight by the GPC method were performed using a GPC apparatus manufactured by Tosoh Corporation (HLC-8120GPC), and are on a polystyrene basis. The measuring conditions are as follows:

Sample concentration: 0.2% by weight (THF solution)

Sample injection volume: 10 μl

Eluent: THF

Flow rate: 0.6 ml/min

Measuring temperature: 40° C.

Column: sample column TSKgel GMH-H(S)

Detector: suggestive refractometer

With regard to the polymer (polyoxyalkylene based polymer having at least one alkenyl group in each molecule), the alkenyl group is not subject to limitation, but an alkenyl group represented by the formula (2) shown below is suitable.

H₂C═C(R²)— Formula (2)

wherein R² is hydrogen or a methyl group.

The mode of bonding of the alkenyl group to the polyoxyalkylene based polymer is not subject to limitation; for example, direct bond of alkenyl group, ether bond, ester bond, carbonate bond, urethane bond, urea bond and the like can be mentioned.

As specific examples of the polymer, a polymer represented by the formula (3): {H₂C═C(R^{3a})—R^{4a}—O}a₁R^{5a} wherein R^{3a} is hydrogen or a methyl group; R^{4a} is a divalent hydrocarbon group having 1 to 20 carbon atoms, optionally having one or more ether groups, R^{5a} is a polyoxyalkylene based polymer residue; a₁ is a positive integer. can be mentioned. As R^{4a} in the formula, specifically, —CH₂—, —CH₂CH₂—, —CH₂CH₂CH₂—, —CH₂CH(CH₃)CH₂—, —CH₂CH₂CH₂CH₂—, —CH₂CH₂OCH₂CH₂—, or —CH₂CH₂OCH₂CH₂CH₂— and the like can be mentioned; for the ease of synthesis, —CH₂— is preferable.

A polymer having an ester bond, represented by the formula (4): {H₂C═C(R^{3b})—R^{4b}—OCO}a₂R^{5b}

wherein R^{3b}, R^{4b}, R^{5b} and a₂ have the same definitions as those of R^{3a}, R^{4a}, R^{5a}, and a₁, respectively can also be mentioned.

A polymer represented by the formula (5): {H₂C═C(R^{3c})}a₃R^{5c} wherein R^{3c}, R^{5c} and a₃ have the same definitions as those of R^{3a}, R^{5a}, and a₁, respectively can also be mentioned.

Furthermore, a polymer having a carbonate bond, represented by the formula (6): {H₂C═C(R^{3d})—R^{4d}—O(CO)O}a₄R^{5d} wherein, R^{3d}, R^{4d}, R^{5d}, and a₄ have the same definitions as those of R^{3a}, R^{4a}, R^{5a} and a₁, respectively can also be mentioned.

It is preferable that at least 1, preferably 1 to 5, more preferably 1.5 to 3, alkenyl groups be present in each molecule of the component A polymer. If the number of alkenyl groups contained in each molecule of the component A polymer is less than 1, the curing quality is insufficient; if the number exceeds 5, the network structure becomes so dense that the polymer sometimes fails to exhibit a good adherence property. The polymer of component A can be synthesized according to the method described in JP-A-2003-292926, and any commercially available product can be used as is.

Any “compound comprising an average of two or more hydrosilyl groups in each molecule” of component B can be used without limitation, as long as it has a hydrosilyl group (a group having an Si—H bond), but from the viewpoint of the ease of obtainment of raw materials and compatibility with the component A, an organohydrogen polysiloxane modified with an organic constituent is particularly preferable. The polyorganohydrogen siloxane modified with an organic constituent more preferably has an average of two to eight hydrosilyl groups in each molecule. Specific examples of the structure of the polyorganohydrogen siloxane include linear or cyclic ones represented by, for example:

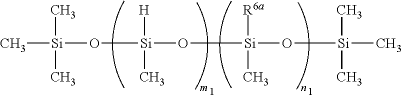

wherein 2≦m₁+n₁≦50, 2≦m₁, and 0≦n₁. R^{6a} is a hydrocarbon group having 2 to 20 carbon atoms in the main chain thereof, optionally comprising one or more phenyl groups,

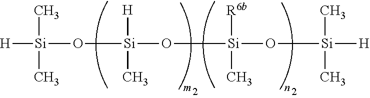

wherein 0≦m₂+n₂50, 0≦m₂, and 0n₂. R^{6b} is a hydrocarbon group having 2 to 20 carbon atoms in the main chain thereof, optionally comprising one or more phenyl groups, or,

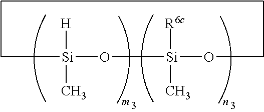

wherein 3≦m₃+n₃≦20, 2≦m₃19, and 0≦n₃≦n₃<18. R^{6c} is a hydrocarbon group having 2 to 20 carbon atoms in the main chain thereof, optionally having one or more phenyl groups and the like, and ones having two or more of these units, represented by the following:

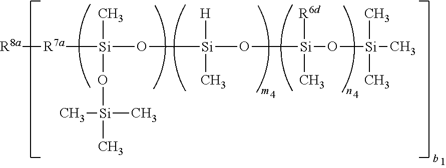

wherein 1≦m₄+n₄≦50, 1≦m₄, and 0≦n₄. R^{6d} is a hydrocarbon group having 2 to 20 carbon atoms in the main chain thereof, optionally having one or more phenyl groups. 2≦b₁. R^{8a} is a divalent to tetravalent organic group, and R^{7a} is a divalent organic group, but R^{7a} may be absent depending on the structure of R^{8a},

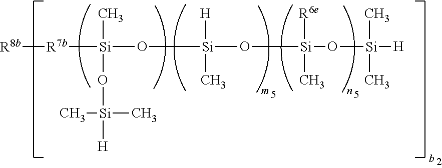

wherein 0≦m₅+n₅≦50, 0≦m₅, and 0n₅. R₆ₑ is a hydrocarbon group having 2 to 20 carbon atoms in the main chain thereof, optionally having one or more phenyl groups. 2≦b₂. R^{8b} is a divalent to tetravalent organic group, and R^{7b} is a divalent organic group, but R^{7b} may be absent depending on the structure of R^{8b}, or

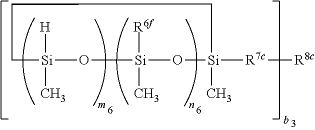

wherein 3≦m₆+n₆≦50, 1≦m₆, and 0n₆. R^{6f} is a hydrocarbon group having 2 to 20 carbon atoms in the main chain thereof, optionally comprising one or more phenyl groups. 2≦b₃. R^{8c} is a divalent to tetravalent organic group, and R^{7c} is a divalent organic group, but R^{7c} may be absent depending on the structure of R^{8c} and the like.

The component B preferably has good compatibility with the component A and the component C, or good dispersion stability in the system. Particularly, if the viscosity of the entire system is low, use of an component whose compatibility with any of the above-described components is low as the component B sometimes causes phase separation and a curing failure.

As a specific example of the component B having relatively good compatibility with the component A and the component C, or relatively good dispersion stability, the following can be mentioned.

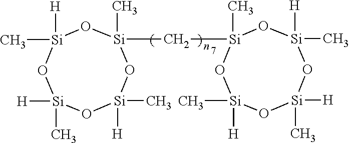

wherein n₇ is an integer of not less than 4 and not more than 10,

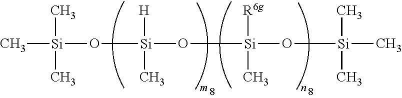

wherein 2≦m₈≦10 and 0≦n₈≦5, R^{6g} is a hydrocarbon group having eight or more carbon atoms.

As specific preferable examples of the component B, polymethylhydrogen siloxane can be mentioned; for assuring compatibility with the component A and adjusting the SiH content, a compound modified with α-olefin, styrene, α-methylstyrene, allylalkyl ether, allylalkyl ester, allylphenyl ether, allylphenyl ester or the like can be mentioned; as an example, the following structure can be mentioned.

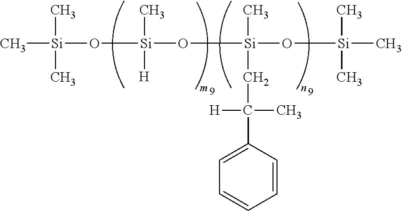

wherein 2≦m₉≦20 and 1≦n≦20.

The component B can be synthesized by a commonly known method, and any commercially available product can be used as is.

The “hydrosilylation catalyst” of component C is not subject to limitation; an optionally chosen one can be used.

As Specific examples, chloroplatinic acid; simple substance platinum; solid platinum carried by a carrier such as alumina, silica, or carbon black; a platinum-vinylsiloxane complex {for example, Ptₙ(ViMe₂SiOSiMe₂Vi)ₘ, Pt[(MeViSiO)₄]ₘ and the like}; a platinum-phosphine complex {for example, Pt (PPh₃)₄, Pt (PBu₃)₄ and the like}; a platinum-phosphite complex {for example, Pt[P(OPh)₃]₄, Pt[P(OBu)₃]₄ and the like}; Pt (acac)₂; the platinum-hydrocarbon composite described in U.S. Pat. No. 3,159,601 and U.S. Pat. No. 3,159,662 of Ashby et al.; the platinum alcoholate catalyst described in U.S. Pat. No. 3,220,972 of Lamoreaux et al. and the like can be mentioned. In the formulas above, Me represents a methyl group, Bu represents a butyl group, Vi represents a vinyl group, Ph represents a phenyl group, acac represents an acetylacetonate, and each of n and m represents an integer.

As Examples of catalysts other than platinum compounds, RhCl (PPh₂)₂, RhCl₃, Rh/Al₂O₂, RuCl₂, IrCl₃, FeCl₃, AlCl₃, PdCl₂.2H₂O, NiCl₂, TiCl₄ and the like can be mentioned.

These catalysts may be used alone, and may be used in combination of 2 kinds or more. With regard to catalyst activity, chloroplatinic acid, a platinum-phosphine complex, a platinum-vinylsiloxane complex, Pt (acac)₂ and the like are preferable.

Although the amount of the component C is not subject to limitation, from the viewpoint of assurance of composition potlife and sheet transparency, the amount is generally not more than 1×10⁻¹ mol, preferably not more than 5.3×10⁻¹ mol, relative to 1 mol of alkenyl groups in the component A; particularly, from the viewpoint of sheet transparency, the amount is more preferably not more than 3.5×10⁻² mol, particularly preferably not more than 1.4×10⁻³ mol. If the amount exceeds 1×10⁻¹ mol relative to 1 mol of alkenyl groups in the component A, the finished sheet is likely to undergo yellowing and the transparency of the sheet tends to be damaged. If the amount of the component C is too low, the composition curing speed is slow, and the curing quality tends to be unstable; therefore, the amount of the component C is preferably not less than 8.9×10⁻⁵ mol, more preferably not less than 1.8×10⁻⁴ mol.

A composition comprising the above-described components A to C is characterized by the ability to exhibit its adherence property (function to adhere to another object) even without the addition, or with the addition of a small amount, of a tackifier resin. It is preferable that the hydrosilyl groups of the component B (compound B) be contained so that the functional group ratio to the alkenyl groups of the component A (compound A) will be not less than 0.3 and less than 2, more preferably not less than 0.4 and less than 1.8, and still more preferably not less than 0.5 and less than 1.5. When the functional group ratio exceeds 2, the crosslinking density increases too much, and it is sometimes impossible to obtain adherence property without the addition, or with the addition of a small amount, of a tackifier resin. When the functional group ratio is less than 0.3, the crosslinking becomes too loose, and adhesive deposit upon redetachment and degraded retention of properties at high temperatures may occur. Hence, by setting a blending ratio of the component A and the component B to fall within a particular range, good adherence property can be achieved even without adding a tackifier resin, and, in addition, the composition can be cured at a practically sufficiently fast line speed.

In the present invention, a transparent adhesive sheet imparted with light resistance may be obtained by sheeting a composition containing components A-C, curing the sheet to give a transparent adhesive sheet, and adding a hindered amine based light stabilizer of the formula (I) (component D) to the transparent adhesive sheet. From the workability and light resistance, transparency and the like of the obtained transparent adhesive sheet, an embodiment for obtaining a transparent adhesive sheet imparted with the intended light resistance by preparing a composition further containing a hindered amine based light stabilizer of the formula (I) (component D) in addition to components A-C, and sheeting and curing said composition is preferable.

In the present invention, the amount of the hindered amine based light stabilizer of the formula (I) (component D) is not particularly limited. It is generally 0.05-5 wt %, preferably 0.1-2 wt %, relative to the polyoxyalkylene based polymer (component A). When the amount of the hindered amine based light stabilizer of the formula (I) (component D) is less than 0.05 wt % relative to the polyoxyalkylene based polymer, a sufficient effect of improving light resistance cannot be obtained easily. On the contrary, when it exceeds 5 wt %, the obtained adhesive sheet unpreferably becomes yellow and tends to cause poor curing.

The composition comprising the components A to D may contain a storage stability improving agent for the purpose of improving the storage stability. As this storage stability improving agent, a commonly known compound known as a storage stabilizer for the above-mentioned component B can be used without limitation. For example, 2-benzothiazolyl sulfide, benzothiazole, thiazole, dimethylacetylene dicarboxylate, diethylacetylene dicarboxylate, 2,6-di-t-butyl-4-methylphenol, butylhydroxyanisole, vitamin E, 2-(4-morpholinyldithio)benzothiazole, 3-methyl-1-butene-3-ol, 2-methyl-3-butene-2-ol, organosiloxane containing an acetylenic unsaturated group, acetylene alcohol, 3-methyl-1-butyl-3-ol, diallyl fumarate, diallyl maleate, diethyl fumarate, diethyl maleate, dimethyl maleate, 2-pentenenitrile, 2,3-dichloropropene and the like can be mentioned, but these are not to be construed as limiting.

An adhesion-imparting agent for improving the adherence (adhesiveness) to the display panel and/or transparent protective plate can be added to the composition as required. As examples of the adhesion-imparting agent, various silane coupling agents, epoxy resins and the like can be mentioned. In particular, a silane coupling agent having a functional group such as an epoxy group, a methacryloyl group, or a vinyl group is preferable because its influence on the curing quality is small and also because it is highly effective for the manifestation of adhesiveness. In combination with a silane coupling agent and an epoxy resin, a catalyst for reacting silyl groups or epoxy groups can be added. When using them, their influence on the hydrosilylation reaction must be taken into consideration. Various fillers, antioxidants, ultraviolet absorbents, pigments, surfactants, solvents, and silicon compounds may be added as appropriate. As specific examples of the above-described fillers, silica micropowder, calcium carbonate, clay, talc, titanium oxide, zinc oxide, diatom aceous earth, barium sulfate and the like can be mentioned. Of these fillers, silica micropowder, particularly micropowder silica having a particle diameter of about 50 to 70 nm (the BET specific surface area is 50 to 380 m²/g) is preferable; in particular, surface-treated hydrophobic silica is particularly preferable because of its high function to improve the strength in the preferred direction. Furthermore, a tackifier resin may be added as required to enhance the properties such as tack thereof; as examples of the tackifier resin, terpene resin, terpene phenol resin, petroleum resin, rosin ester and the like can be mentioned, one of which can be freely selected according to the intended use. For the property improvements, resins such as phenol resin, acrylic resin, styrene resin, and xylene resin can be added. An adhesive component such as an acrylic adhesive, a styrene block based adhesive, or an olefin based adhesive can be added for the same purpose.

The transparent adhesive sheet of the present invention is preferably prepared by the following method.

A composition comprising the above-described components A to D, along with an organic solvent as required, is charged to a stirrer with vacuum function and stirred and hence defoamed in a vacuum conditions (under vacuum), and the resulting fluidized product after the vacuum defoaming is applied (cast) on various supports and thermally treated to obtain a sheet. The composition is thermally cured by a heat treatment to give a sheet made of a cured product. Coating on the support can be performed using, for example, a commonly known coating apparatus such as a gravure coater; a roll coater such as a kiss coater or a comma coater; a die coater such as a slot coater or a fountain coater; a squeeze coater, a curtain coater and the like. Regarding the heat treatment conditions in this case, it is preferable that the composition be heated at 50 to 200° C. (preferably 100 to 160° C.) for about 0.01 to 24 hours (preferably 0.05 to 4 hours). As the above-described stirrer with vacuum function, a commonly known stirrer equipped with vacuum apparatus may be used; specifically, a planetary (revolution/rotation type) stirring defoaming apparatus, a defoaming apparatus equipped with a disperser, and the like can be mentioned. The degree of pressure reduction in performing vacuum defoaming is preferably not more than 10 kPa, more preferably not more than 3 kPa. Stirring time varies also depending on the choice of stirrer and the throughput of fluidized product, and is generally preferably about 0.5 to 2 hours. As a result of the defoaming treatment, air bubbles (voids) are not substantially present in the sheet, and superior optical property (transparency) is exhibited.

While the thickness of the transparent adhesive sheet of the present invention varies depending on the kind and the like of a display device (flat panel display), it is generally 1000 μm or less, preferably 500 μm or less, to provide a thin display device (flat panel display). However, the lower limit of the thickness is preferably 10 μm, since sufficiently high impact resistance is difficult to achieve when the thickness is too small. The transparent adhesive sheet of the present invention can be used not only for adhesion of a transparent protective plate (acrylic board, glass plate) to a display panel (i.e., interposed between transparent protective plate and display panel to allow adhesion to the both), but also as a protective sheet by adhering itself alone to a display panel. When it is used for adhesion between a transparent protective plate and a display panel, the thickness is preferably 15-1000 μm, more preferably 25-500 μm. When it is used as a protective sheet, the thickness is preferably 25-1000 μm, more preferably 50-500 μm.

In flat panel display, a laminate structure wherein a transparent protective plate is placed on a display panel (display module) of a display via other functional layer (e.g., glass, plastic film etc. with transparent electrode layer formed in touch panel system) interposed between them and they are closely adhered integrally may be employed. The transparent adhesive sheet of the present invention can also be used for adhesion between such functional layer and a transparent protective plate, or adhesion between such functional layer and a display panel (display module).

The transparent adhesive sheet of the present invention can be applied to various flat panel displays such as a liquid crystal display (LCD), a plasma display (PDP), an organic or inorganic electroluminescence display (ELD), a surface-conduction electron-emitter display (SED) and the like. Using the transparent adhesive sheet of the present invention, therefore, a flat panel display wherein a transparent protective plate is directly or via other functional layer interposed between them closely adhered integrally to a display module (display panel), or a flat panel display wherein a display module (display panel) is directly protected with the transparent adhesive sheet of the present invention (protective sheet) without using a transparent protective plate can be obtained. As a result, a flat panel display capable of maintaining high impact resistance and visibility of good display images for a long period can be realized.

The transparent adhesive sheet of the present invention can be basically prepared without a solvent. In other words, components A-C and the hindered amine based light stabilizer of the formula (I) (component D) are compatible. Therefore, it is characterized by a less amount of low molecular weight and high-volatile oligomer component and monomer component. Thus, it also provides an advantage of less adverse influence on the human body even when used for a flat panel display mounted equipment for daily use in recent years.

The transparent adhesive sheet of the present invention needs to be processed into a sheet having a small area size depending on the size of the flat panel display. Considering the mass productivity (production efficiency), for example, it is preferable to prepare a roll having a laminate constitution of first support (base separator)/cured product layer of composition containing the above-mentioned components A-D (transparent adhesive sheet)/second support (cover separator), and apply punching processing while unwinding the roll for production.

The above-mentioned roll is prepared by, for example, coating the first support with a release agent for a release treatment, stirring and vacuum degassing a composition containing the above-mentioned components A-D, applying (casting) fluid substance after vacuum degassing on the first support, heat-treating same to give a sheet, laminating the second support after a release treatment thereon, and winding the laminate to give a roll.

Specific examples of the first and the second support include single layer films (sheets) made of thermoplastic resins such as polyester (e.g., polybutylene terephthalate (PBT) and the like), ionomer resin wherein molecules of ethylene-methacrylic acid copolymer are crosslinked with metal ion (Na⁺, Zn²⁺ etc.), EVA (ethylene-vinyl acetate copolymer), PVC (polyvinyl chloride), EEA (ethylene•ethylacrylate copolymer), PE (polyethylene), PP (polypropylene), polyamide, poly butyral, polystyrene and the like; various thermoplastic elastomers showing rubber elasticity such as polystyrene series, polyolefin series, polydiene series, vinyl chloride series, polyurethane series, polyester series, polyamide series, fluorine series, chlorinated polyethylene series, polynorbornane series, polystyrene•polyolefin copolymer series, (hydrogenated) polystyrene•butadiene copolymer series, polystyrene•vinylpolyisoprene copolymer series and the like; polyolefin such as polyethylene, polypropylene and the like blended with a thermoplastic elastomer and the like, films (sheets) having multiple layers (laminate) made of polyolefin (polyprobylene (PP) or polyethylene (PE) etc.)/thermoplastic resin (e.g., EVA)/polyolefin, polyolefin (PP or PE)+thermoplastic elastomer/polyolefin (PP or PE), PP/PE/PP and the like, multi-layer (laminate) of composite polyolefin+thermoplastic elastomer with varying blending ratios, etc., and the like. In addition, impregnated paper, coated paper, quality paper, craft paper, cloth, acetate cloth, non-woven fabric, glass cloth and the like can be mentioned.

Examples the release agents to be used for the first and the second support include silicone release agent, fluorine release agent, long chain alkyl release agent and the like. Of these, a silicone release agent is preferable. As the curing method, a curing method such as UV irradiation, electron beam irradiation and the like are preferably used. Furthermore, of the silicone release agents, a cation polymerizable UV curing silicone release agent is preferable. A cation polymerizable UV curing silicone release agent is a mixture of a cation polymerizable silicone (polyorganosiloxane having an epoxy functional group in a molecule) and an onium salt photoinitiator. Such agent wherein the onium salt photoinitiator is a boron photoinitiator is particularly preferable. Using such a cation polymerizable UV curing silicone release agent wherein the onium salt photoinitiator is a boron photoinitiator, particularly good release property (mold releasability) can be obtained. A cation polymerizable silicone (polyorganosiloxane having an epoxy functional group in a molecule) has at least two epoxy functional groups in one molecule, which may be linear or branched, or a mixture of these. While the kind of an epoxy functional group contained in polyorganosiloxane is not particularly limited, it only needs to permit progress of cationic ring-opening polymerization by an onium salt photoinitiator. Specific examples thereof include γ-glycidyloxypropyl group, β-(3,4-epoxycyclohexyl)ethyl group, β-(4-methyl-3,4-epoxycyclohexyl)propyl group and the like. Such cation polymerizable silicone (polyorganosiloxane having an epoxy functional group in a molecule) is marketed and a commercially available product can be used. For example, UV9315, UV9430, UV9300, TPR6500, TPR6501 and the like manufactured by Toshiba Silicone Co., Ltd., X-62-7622, X-62-7629, X-62-7655, X-62-7660, X-62-7634A and the like manufactured by Shin-Etsu Chemical Co., Ltd., Poly200, Poly201, RCA200, RCA250, RCA251 and the like manufactured by Arakawa Chemical Industries, Ltd. can be mentioned.

Of the cationic polymerizable silicones, polyorganosiloxane comprising the following structural units (A)-(C) is particularly preferable.

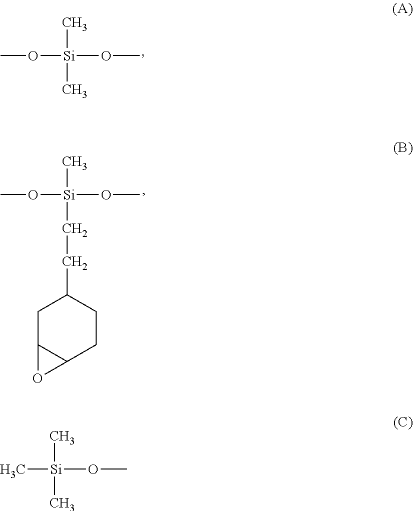

In polyorganosiloxane comprising such structural units (A)-(C), the composition ratio ((A):(B): C)) of structural units (A)-(C) is particularly preferably 50-95:2-30:1-30 (mol %), and especially preferably 50-90:2-20:2-20 (mol %). Polyorganosiloxane comprising such structural units (A)-(C) is available as Poly200, Poly201, RCA200, X-62-7622, X-62-7629 and X-62-7660.

On the other hand, as the onium salt photoinitiator, a known product can be used without particular limitation. Specific examples include a compound represented by (R¹)₂I⁺X⁻, ArN₂⁺X⁻ or (R¹)₃S⁺X⁻ (wherein R¹ is alkyl group and/or aryl group, Ar is aryl group, X⁻ is [B(C₆H₅)₄]⁻, [B(C₆F₅)₄]⁻, [B(C₆H₄CF₃)₄]⁻, [(C₆F₅)₂BF₂]⁻, [C₆F₅BF₃]⁻, [B (C₆H₃F₂)₄]⁻, BF₄⁻, PF₆⁻, ASF₆⁻, HSO₄⁻, ClO₄⁻ and the like). Of these, a compound of the formula (boron photoinitiator) wherein X⁻ is [B(C₆H₅)₄]⁻, [B(C₆F₅)₄]⁻, [B(C₆H₄CF₃)₄]⁻, [(C₆F₅)₂BF₂]⁻, [C₆F₅BF₃]⁻, [B(C₆H₃F₂)₄]⁻ or BF₄⁻is preferable, and a compound represented by (R¹)₂I⁺[B (C₆F₅)₄] (wherein R¹ is substituted or unsubstituted phenyl group) (alkyl iodonium, tetrakis(pentafluorophenyl)borate) is particularly preferable. As the onium salt photoinitiator, antimony (Sb) initiator is conventionally known. However, when an antimony (Sb) initiator is used, increase of the peel force occurs and detachment of a transparent adhesive sheet from a separater tends to be difficult.

While the amount of the onium salt photoinitiator to be used is not particularly limited, it is about preferably 0.1-10 parts by weight relative to 100 parts by weight of the cationic polymerizable silicone (polyorganosiloxan). When the amount of use is smaller than 0.1 part by weight, curing of the silicone peel layer may become insufficient. When the amount of use is greater than 10 parts by weight, the cost becomes impractical. When a cationic polymerizable silicone (polyorganosiloxan) and an onium salt photoinitiator are mixed, the onium salt photoinitiator may be dissolved or dispersed in an organic solvent and then mixed with polyorganosiloxan. Specific examples of the organic solvent include alcohol solvents such as isopropyl alcohol, n-butanol and the like; ketone solvents such as acetone, methyl ethyl ketone and the like; ester solvents such as ethyl acetate, and the like, and the like.

A release agent can be applied, for example, using a general coating apparatus such as those used for roll coater method, reverse coater method, doctor blade method and the like. While the coating amount (solid content) of the release agent is not particularly μlimited, it is generally about 0.05-6 mg/cm².

### EXAMPLES

The present invention is explained in more detail in the following by illustrating the Examples and Comparative Examples. In the Examples and Comparative Examples, the physical properties of adhesive sheets were evaluated (tested) by the following methods.

### [Weather Resistant Test]

An adhesive sheet having an adhesive layer with a thickness 100-250 μm was cut into 50 mm×50 mm to give a test piece. The sheet was adhered to a glass substrate (S-1111 (trade name) manufactured by Matsunami Trading Co., Ltd.) to give a measurement sample. In the weather resistant test, the test piece (sample) was placed on the light receiving surface side of the test apparatus below and, under the following test conditions, the test was performed with a separator (support) of the test piece detached where the time necessary for an adhesive to liquefy was measured.

test apparatus: Super Xenon Weather Meter (SX75) manufactured by Suga Test Instruments Co., Ltd.

test conditions: radiation 180 W/m²
temperature-humidity black panel
temperature 63° C., humidity 50% RH

### [Yellowing Value Measurement]

An adhesive sheet having an adhesive layer with a thickness 100-250 μm was cut into 50 mm×25 mm to give a test piece. The sheet was adhered to a glass substrate (S-1111 (trade name) manufactured by Matsunami Trading Co., Ltd.) to give a measurement sample. For the measurement of yellowing value, a transmittance measuring apparatus (DOT-3uv-vis manufactured by Murakami Color Research Laboratory) was used, the test piece (sample) was placed on the light receiving surface side of the test apparatus, the measurement was performed with a separator (support) of the test piece detached, and the yellowing degree was compared based on the obtained b value (b value of not more than 1 was taken as the threshold value free of yellowing).

### Example 1

A composition containing a polyoxyalkylene based polymer for component A (number average molecular weight: about 20,000) in the aforementioned specification, a hydrosilyl compound for component B (in an amount that affords a functional group ratio (molar ratio) of 0.75 (its hydrosilyl group amount relative to alkenyl group amount of polyoxyalkylene based polymer for component A), and a hydrosilylation catalyst for component C (0.9×10⁻³ mol per 1 mol of alkenyl group in component A) (manufactured by KANEKA Corporation), and bis(1,2,2,6,6-pentamethyl-4-piperidinyl)sebacate (Tinuvin 765 (trade name) manufactured by Ciba Specialty Chemicals), which is a light stabilizer, in 0.1 wt % relative to component A, were placed in a stirrer with a vacuum apparatus (Mini Dappo manufactured by SEATEC CORPORATION), and the mixture was stirred in vacuo (100 Pa) for 1 hr for defoaming. Then, the vacuum defoamed composition was applied (cast) onto a base separator (support) comprised of a polyester film (thickness: 100 μm) subjected to a release treatment, using a roll coater at room temperature to a composition thickness of 200 μm. The composition was cured by heating in a heating oven at 130° C. for 10 min. A cover separator (release liner) comprised of a polyester film (thickness: 100 μm) and subjected to a release treatment in the same manner was adhered to the thus-obtained cured sheet to give a transparent adhesive sheet (thickness: 100 μm).

### Examples 2, 3

In the same manner as in Example 1 except that the thickness of the composition applied was changed to 150 μm and 250 μm, transparent adhesive sheets were prepared.

### Examples 4-6

In the same manner as in Example 1 except that the amount of the light stabilizer (Tinuvin 765) added was changed to 0.6 wt % relative to component A, a transparent adhesive sheet was prepared (Example 4), and further, the thickness of the composition applied was changed to 150 μm and 250 μm to give transparent adhesive sheets (Examples 5 and 6, respectively).

### Examples 7-9

In the same manner as in Example 1 except that the amount of the light stabilizer (Tinuvin 765) added was changed to 1.0 wt % relative to component A, a transparent adhesive sheet was prepared (Example 7), and further, the thickness of the composition applied was changed to 150 μm and 250 μm to give transparent adhesive sheets (Examples 8 and 9, respectively).

### Examples 10-18

In the same manner as in Examples 1-9 except that the light stabilizer was changed to N-(1-acetyl-2,2,6,6-tetramethyl-4-piperidinyl)-2-dodecyl-succinimide (Hostavin 3058 liquid (trade name) manufactured by cliant Japan), transparent adhesive sheets were respectively prepared.

### Comparative Examples 1-3

In the same manner as in Examples 1-3 except that the light stabilizer was not added, transparent adhesive sheets were prepared.

The following Table 1 shows the results of Examples 1-18 and Comparative Examples 1-3.

TABLE 1

| | thickness of | | | | lique- |
|---|---|---|---|---|---|
| | adhesive | light stabilizer | | b value | faction |
| | sheet | | amount | (yellowing | time |
| | (μm) | kind | (%) | value) | (hr) |
| Example 1 | 100 | Tinuvin | 0.10 | 0.22 | 35 |
| Example 2 | 150 | 765 | | 0.23 | 45 |
| Example 3 | 250 | | | 0.24 | 45 |
| Example 4 | 100 | | 0.60 | 0.21 | 65 |
| Example 5 | 150 | | | 0.24 | 65 |
| Example 6 | 250 | | | 0.25 | 70 |
| Example 7 | 100 | | 1.00 | 0.21 | 75 |
| Example 8 | 150 | | | 0.23 | 75 |
| Example 9 | 250 | | | 0.25 | 75 |
| Example 10 | 100 | Sanduvor | 0.10 | 0.30 | 25 |
| Example 11 | 150 | 3058 | | 0.33 | 25 |
| Example 12 | 250 | | | 0.35 | 25 |
| Example 13 | 100 | | 0.60 | 0.32 | 35 |
| Example 14 | 150 | | | 0.33 | 40 |
| Example 15 | 250 | | | 0.35 | 40 |
| Example 16 | 100 | | 1.00 | 0.35 | 50 |
| Example 17 | 150 | | | 0.36 | 55 |
| Example 18 | 250 | | | 0.38 | 55 |

| | | | |
|---|---|---|---|
| Comparative | 100 | 0.21 | 12 |
| Example 1 | | | |
| Comparative | 150 | 0.23 | 15 |
| Example 2 | | | |
| Comparative | 250 | 0.24 | 15 |
| Example 3 | | | |

This application is based on a patent application No. 2008-034769 filed in Japan, the contents of which are incorporated in full herein.

1. A transparent adhesive sheet for flat panel display, comprising a polyoxyalkylene based polymer as a main component and a hindered amine based light stabilizer represented by the formula (I): 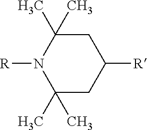
wherein R is an alkyl group or an alkylcarbonyl group, and R′ is a hydrogen atom or an organic group bonded to the 4-position of a piperidyl group via oxygen or nitrogen.

2. The transparent adhesive sheet for flat panel display according to claim 1, which consists of a cured product obtained by curing a composition comprising the following components A to D:
A: a polyoxyalkylene based polymer having at least one alkenyl group in each molecule
B: a compound having an average of two or more hydrosilyl groups in each molecule
C: a hydrosilylation catalyst, and
D: a hindered amine based light stabilizer represented by the formula (I): 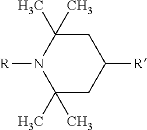
wherein R is an alkyl group or an alkylcarbonyl group, and R′ is a hydrogen atom or an organic group bonded to the 4-position of a piperidyl group via oxygen or nitrogen.

3. The transparent adhesive sheet for flat panel display according to claim 2, wherein the amount of component D is 0.05-5 wt % relative to component A.

4. A flat panel display comprising a display panel and the transparent adhesive sheet according to claim 1, which is adhered to the display panel.

5. A flat panel display comprising a display panel and the transparent adhesive sheet according to claim 2, which is adhered to the display panel.

6. A flat panel display comprising a display panel and the transparent adhesive sheet according to claim 3, which is adhered to the display panel.
